(19) United States
(12) Patent Application Publication
(10) Pub. No.: US 2026/0184288 A1
(43) Pub. Date: Jul. 2, 2026

(54) WINDSHIELD WIPER ASSEMBLY STRUCTURE

(71) Applicant: DANYANG UPC AUTO PARTS CO., LTD., ZHENJIANG (CN)

(72) Inventors: Che-Wei CHANG, New Taipei City (TW); Cheng-Kai YANG, New Taipei City (TW); Chuan-Chih CHANG, New Taipei City (TW)

(21) Appl. No.: 19/404,980

(22) Filed: Dec. 1, 2025

(30) Foreign Application Priority Data
Dec. 31, 2024 (CN) 2024233200065

(51) Int. Cl. B60S 1/38; B60S 1/40

(52) U.S. Cl. CPC B60S 1/3806; B60S 1/4006

(57) ABSTRACT

A windshield wiper includes a pivot frame, a mount, an adapter base, an adapter cover and a scraper. The pivot frame includes a pivot base and a pair of extension arms connected to two sides of the pivot base respectively, and the pivot base has a plurality of buckle slots. The mount has an accommodation space and a plurality of buckle hooks, and the mount is combined with the pivot base by interlocking the buckle hook with the buckle slot. The adapter base is attached into the accommodation space and includes a base and a first pivot part located on the base for pivoting a second pivot part of a drive arm. The adapter cover is pivoted to a first pivot part and engaged with the base to prevent the drive arm from detaching from the base. The scraper is combined with the bottom side of the mount.

### BACKGROUND OF THE DISCLOSURE

### Technical Field

The present disclosure relates to windshield wipers, and particularly relates to a windshield wiper assembly structure.

### Description of Related Art

In general, an automotive wiper is mounted on the outer surface of an automotive windshield and connected to an automotive wiper drive arm to enable the wiper to oscillate repeatedly across the windshield surface, thereby removing rainwater, dirt, and other foreign substances from the windshield.

Furthermore, the automotive wiper primarily includes a wiper drive arm connected to an adapter, and the bottom side of the adapter is attached to a metal bracket and a scraper. This allows the wiper drive arm to drive the adapter and press the metal bracket and scraper to clean the windshield. The adapter and wiper drive arm are combined by press-fit or riveting, so they tend to separate from each other after prolonged use. This affects the force application of the wiper drive arm, and definitely requires improvements.

In view of the aforementioned drawbacks of the related art, the discloser of the present disclosure has made it a goal to conduct research and apply theories to overcome the drawbacks of the related art.

### SUMMARY OF THE DISCLOSURE

The primary objective of the present disclosure is to provide a windshield wiper assembly structure to ensure the connection between the adapter and the wiper drive arm, and to simplify the wiper assembly structure.

To achieve the aforementioned objective, the present disclosure discloses a windshield wiper assembly structure, which includes a pivot frame, a mount, an adapter base, an adapter cover and a scraper. The pivot frame includes a pivot base and a pair of extension arms connected to two sides of the pivot base respectively, and the pivot base has a plurality of buckle slots. The mount has an accommodation space and a plurality of buckle hooks, and the mount is combined with the pivot base by interlocking the buckle hooks with the buckle slots. The adapter base is attached into the accommodation space, and includes a base and a first pivot part disposed on the base, and a second pivot part for pivoting the drive arm. The adapter cover is pivotally connected to the first pivot part and buckled to the base, for preventing the drive arm from detaching from the base.

In an embodiment of the present disclosure, the windshield wiper assembly structure further includes a pair of air guide deflectors combined with two sides of the mount respectively, each air guide deflector includes a pair of snap pieces and a bump located between the pair of snap pieces, two sides of the mount are provided with a pair of hooks and a hook hole, each of the air guide deflectors is combined with a side of the mount by interlocking the pair of snap pieces with the pair of hooks and interlocking the bump with the hook hole.

In an embodiment of the present disclosure, the pivot base includes a pivot shaft and two support plates spaced apart between the pair of extension arms, and the pivot shaft spans across the two support plates.

In an embodiment of the present disclosure, the buckle hooks are symmetrically located on two opposite sides of the accommodation space.

In an embodiment of the present disclosure, the first pivot part and second pivot part are respectively a pivot.

In an embodiment of the present disclosure, the adapter cover includes a cover plate and a through hole formed on the cover plate, and the adapter cover is combined with the adapter base by passing the first pivot part into the through hole.

In an embodiment of the present disclosure, the adapter cover includes a pair of snap pieces disposed on the cover plate, the base is provided with a pair of snap holes, and the adapter cover is positioned on the base by engaging the pair of snap pieces with the pair of snap holes.

In an embodiment of the present disclosure, the adapter cover includes a pull tab protruding from the periphery of the cover plate.

In an embodiment of the present disclosure, the through hole and the pair of snap pieces are located on two opposite sides of the cover plate respectively.

In an embodiment of the present disclosure, the adapter cover includes a plurality of reinforcing ribs, and the reinforcing ribs are spaced apart on the bottom side of the cover plate.

Compared to the prior art, the mount of the windshield wiper assembly structure of the present disclosure is combined with the pivot frame, the adapter base is combined with the mount, and the adapter cover is pivoted to the adapter base, so that when the drive arm is connected to the adapter base, the adapter cover blocks the drive arm to prevent it from detaching from the adapter base. This ensures the connection between the adapter and the wiper drive arm, simplifies the wiper assembly structure, and increases the practicality and convenience of use.

### BRIEF DESCRIPTION OF THE DRAWINGS

FIG. 1 is a schematic view illustrating the use of a windshield wiper assembly structure of the present disclosure;

FIG. 2 is an exploded perspective view of the windshield wiper assembly structure of the present disclosure;

FIG. 3 is a schematic view of showing the connection of a mount of the present disclosure;

FIGS. 4 and 5 are cross-sectional views of a windshield wiper assembly structure of the present disclosure; and

FIG. 6 is a cross-sectional view illustrating the use of a windshield wiper assembly structure of the present disclosure.

### DETAILED DESCRIPTION

The detailed description and technical content of the present disclosure are illustrated below with reference to the accompanying drawings. However, the accompanying drawings are intended for the illustrative purposes only, but not intended to limit the scope of the present disclosure.

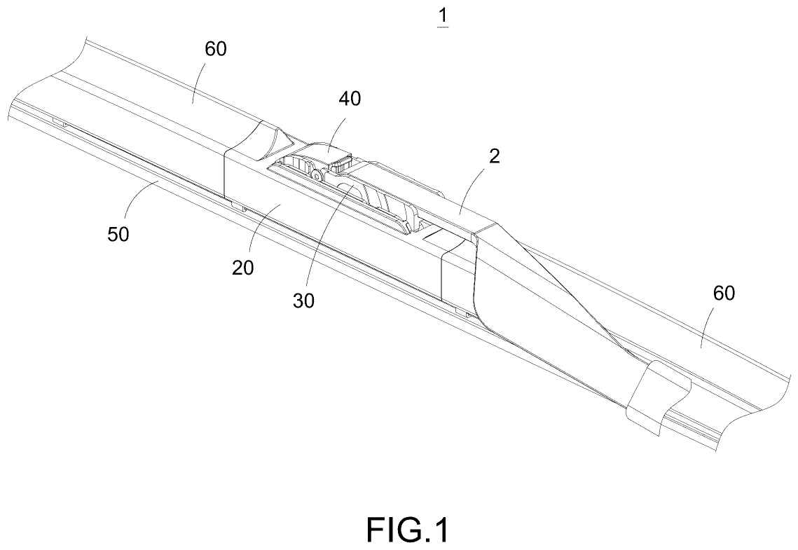

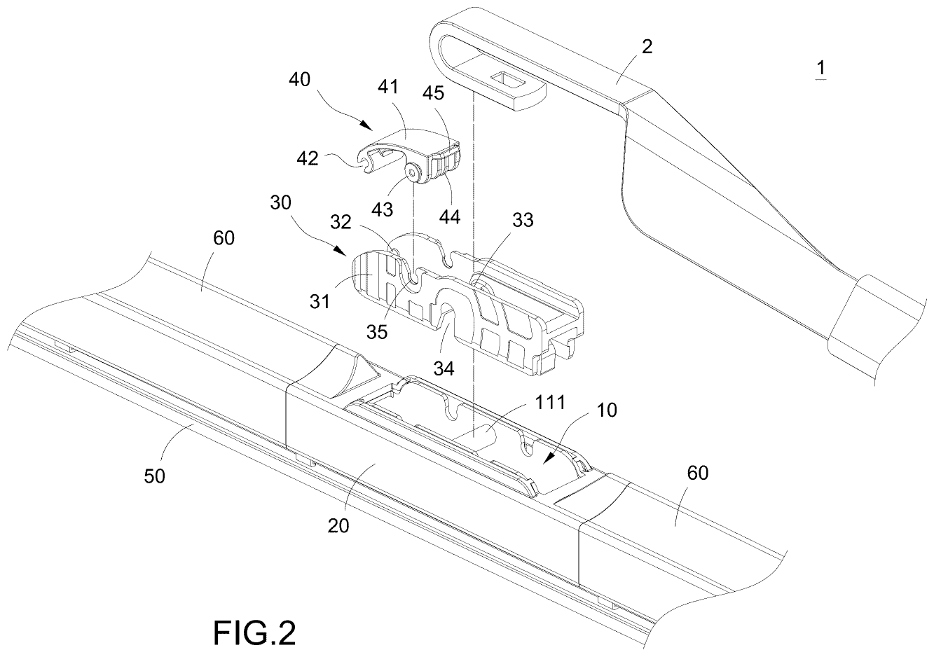

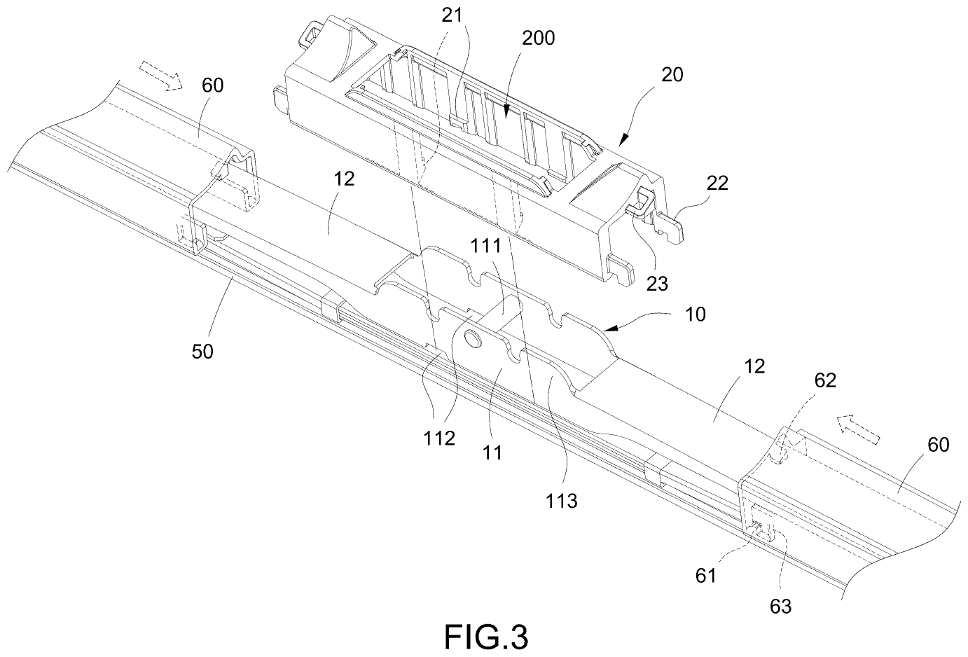

With reference to FIGS. 1 to 3 for the schematic view of use and the exploded view of a windshield wiper assembly structure, and the schematic view of the connection of a mount in accordance with the present disclosure respectively, the windshield wiper assembly structure 1 includes a pivot frame 10, a mount 20, an adapter base 30, an adapter cover 40 and a scraper 50. The mount 20 is combined with the pivot frame 10. The adapter base 30 is combined with the mount 20. The adapter cover 40 is pivoted to the adapter base 30. The scraper 50 is combined with the bottom side of the pivot frame 10. In this way, the adapter base 30 is combined with a drive arm 2. In addition, the adapter cover 40 is provided for blocking the drive arm 2 to prevent the drive arm 2 from detaching from the adapter base 30. It should be noted that the present disclosure allows different types of adapter bases 30 to fit the different models of drive arms 2 for installation on different vehicle models.

The pivot frame 10 of the present disclosure includes a pivot base 11 and a pair of extension arms 12 connected to two sides of the pivot base 11 respectively. The pivot base 11 has a pivot shaft 111 and a plurality of buckle slots 112. In addition, the pivot base 11 includes two support plates 113 spaced apart between the pair of extension arms 12, and the pivot shaft 111 spans across the two support plates 113.

The mount 20 has an accommodation space 200 and a plurality of buckle hooks 21. The mount 20 is combined with the pivot base 11 by engaging the buckle hooks 21 with the buckle slot 112 of the pivot frame 10. In this embodiment, the buckle hooks 21 are symmetrically disposed on two opposite sides of the accommodation space 200.

In this embodiment, the windshield wiper assembly structure 1 further includes a pair of air guide deflectors 60. The pair of air guide deflectors 60 are combined with two sides of the mount 20. In an exemplary embodiment, each air guide deflector 60 has a pair of snap pieces 61 and a bump 62 located between the pair of snap pieces 61. The mount 20 has a pair of hooks 22 and a hook hole 23 on each of its two sides. Furthermore, each of the air guide deflectors 60 is attached to a side of the mount 20 by interlocking the pair of snap pieces 61 with the pair of hooks 22, and interlocking the bump 62 with the hook hole 23. In an exemplary embodiment, each air guide deflector 60 has a pair of fold sides 63 at an end facing the mount 20. Each snap piece 61 is located between the inner wall surface of the air guide deflector 60 and each fold side 63.

The adapter base 30 is combined into the accommodation space 200 and includes a base 31, a first pivot part 32 mounted on the base 31, and a second pivot part 33 for pivoting the drive arm 2. In this embodiment, the first pivot part 32 and the second pivot part 33 are respectively a pivot. Furthermore, the bottom side of the base 31 is provided with a pivot hole 34 for combining the pivot shaft 111 of the pivot base 11.

Furthermore, the adapter cover 40 is pivotally connected to the first pivot part 32 and engaged with the base 31, thereby preventing the drive arm 2 from detaching from the base 31. In an exemplary embodiment, the adapter cover 40 includes a cover plate 41 and a through hole 42 formed on the cover plate 41. The adapter cover is connected to the adapter base 30 by passing the first pivot part 32 through the through hole 42. Furthermore, the adapter cover 40 includes a pair of snap pieces 43 disposed on the cover plate 41. The base 31 of the adapter base 30 is provided with a pair of snap holes 35. The adapter cover 40 is combined with the base 31 by engaging the pair of snap pieces 43 with the pair of snap holes 35.

In this embodiment, the through hole 42 and the pair of snap pieces 43 are located on two opposite sides of the cover plate 41 respectively. Furthermore, the adapter cover 40 includes a plurality of reinforcing ribs 44. The reinforcing ribs 44 are spaced apart on the bottom side of the cover plate 41.

It is noteworthy that the adapter cover 40 includes a pull tab 45 protruding from the periphery of the cover plate 41. The pull tab 45 is provided for users to apply a force to lift the adapter cover and facilitate the installation of the drive arm 2.

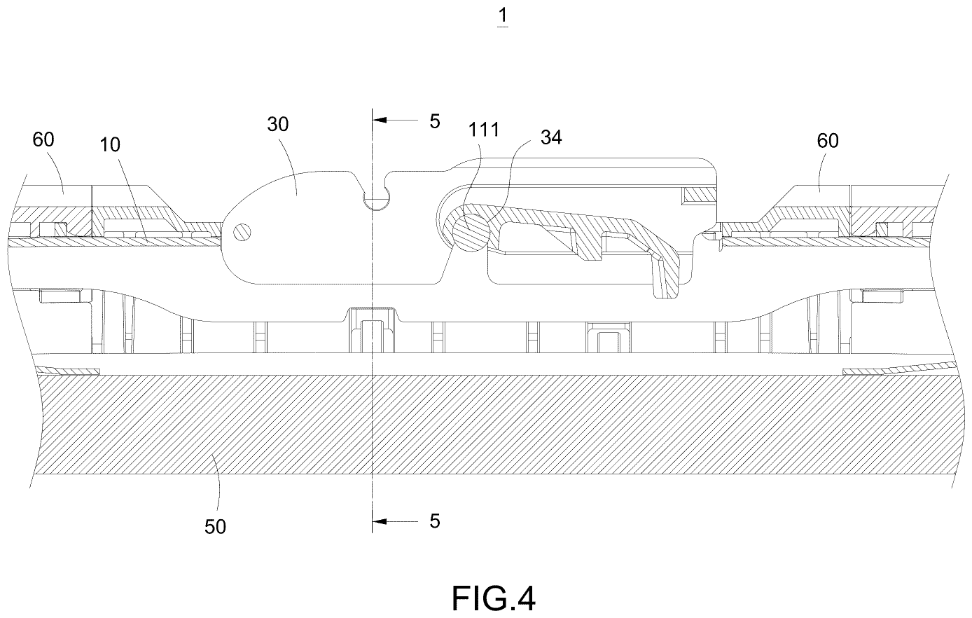

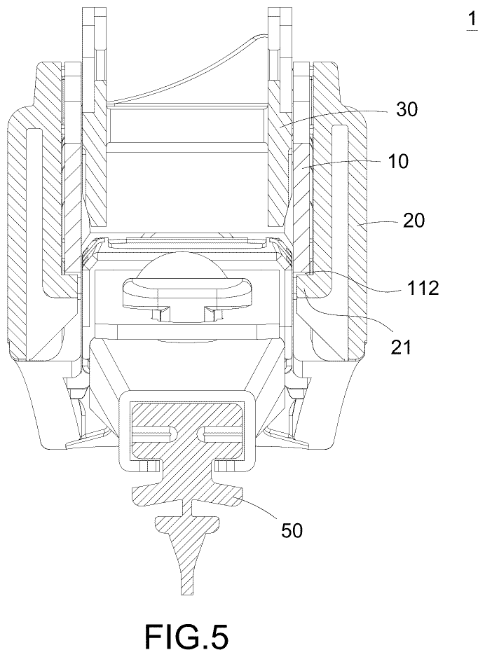

With reference to FIGS. 4 and 5 for the cross-sectional views of the windshield wiper assembly structure of the present disclosure, the pivot hole 34 of the adapter base 30 of the present disclosure as shown in FIG. 4 is combined with the pivot shaft 111 of the pivot frame 10. The scraper 50 is combined with the bottom side of the pivot frame 10. The pair of air guide deflectors 60 are combined with two sides of the mount 20.

As shown in FIG. 5, the mount 20 is combined with the pivot frame 10 by engaging the buckle hooks 21 with the buckle slots 112 of the pivot frame 10. The adapter base 30 is combined with the mount 20. The adapter cover 40 is pivotally connected to the adapter base 30. The scraper 50 is combined with the bottom side of the pivot frame 10.

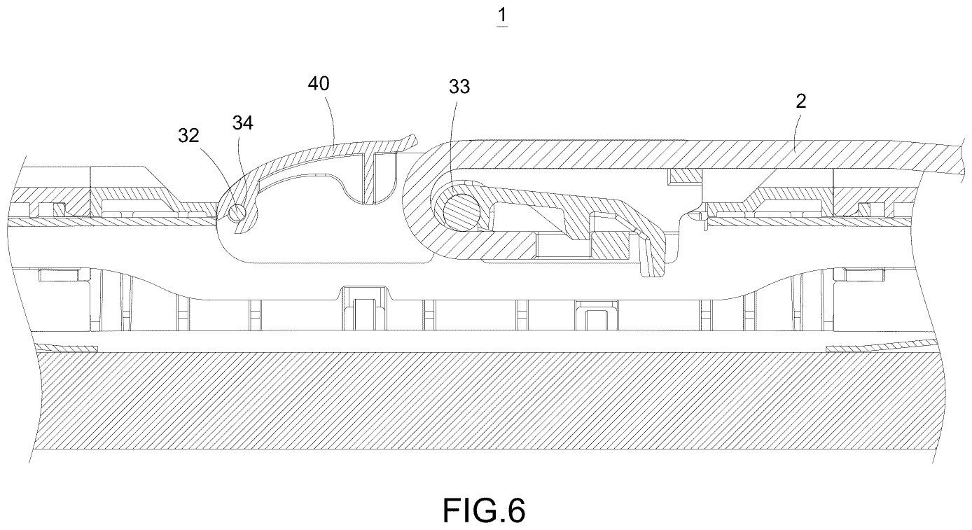

With reference to FIG. 6 for the cross-sectional view illustrating the use of the windshield wiper assembly structure of the present disclosure, the drive arm 2 is pivotally connected to the second pivot part 33. The adapter cover 40 is pivotally connected to the first pivot part 32, and an end of the adapter cover 40 is located above the drive arm 2 for blocking the drive arm 2 and preventing the detachment of the drive arm 2.

The embodiments above are intended to enable persons having ordinary skill in the art to clearly understand the technical content of the present disclosure and implement the disclosure accordingly, but these embodiments are not intended to limit the scope of the present disclosure. Therefore, it is to be understood that all variations of equivalent techniques falling within the spirit and scope of the appended claims should be similarly included in the scope of the present disclosure.

What is claimed is:

1. A windshield wiper assembly structure, for combining a drive arm, the windshield wiper assembly structure comprising:
a pivot frame, comprising a pivot base and a pair of extension arms coupled to two sides of the pivot base respectively, and the pivot base being provided with a plurality of buckle slots;
a mount, provided with an accommodation space and a plurality of buckle hooks, and the mount being combined with the pivot base by interlocking the buckle hooks with the buckle slots;
an adapter base, attached into the accommodation space, and comprising a base, a first pivot part disposed on the base, and a second pivot part for pivoting the drive arm;
an adapter cover, pivotally coupled to the first pivot part and buckled to the base, for preventing the drive arm from detaching from the base; and
a scraper, combined with a bottom side of the mount.

2. The windshield wiper assembly structure according to claim 1, further comprising a pair of air guide deflectors combined with two sides of the mount respectively, each air guide deflector comprising a pair of snap pieces and a bump located between the pair of snap pieces, two sides of the mount being provided with a pair of hooks and a hook hole, each of the air guide deflectors being combined with a side of the mount by interlocking the pair of snap pieces with the pair of hooks and interlocking the bump with the hook hole.

3. The windshield wiper assembly structure according to claim 1, wherein the pivot base comprises a pivot shaft and two support plates spaced apart between the pair of extension arms, and the pivot shaft spans across the two support plates.

4. The windshield wiper assembly structure according to claim 1, wherein the buckle hooks are symmetrically located on two opposite sides of the accommodation space.

5. The windshield wiper assembly structure according to claim 1, wherein the first pivot part and the second pivot part are respectively a pivot.

6. The windshield wiper assembly structure according to claim 5, wherein the adapter cover comprises a cover plate and a through hole formed on the cover plate, and the adapter cover is combined with the adapter base by passing the first pivot part into the through hole.

7. The windshield wiper assembly structure according to claim 6, wherein the adapter cover comprises a pair of snap pieces disposed on the cover plate, the base is provided with a pair of snap holes, and the adapter cover is positioned on the base by engaging the pair of snap pieces with the pair of snap holes.

8. The windshield wiper assembly structure according to claim 7, wherein the adapter cover comprises a pull tab protruding from the periphery of the cover plate.

9. The windshield wiper assembly structure according to claim 7, wherein the through hole and the pair of snap pieces are located on two opposite sides of the cover plate respectively.

10. The windshield wiper assembly structure according to claim 7, wherein the adapter cover comprises a plurality of reinforcing ribs spaced apart on the bottom side of the cover plate.
